(19) United States
(12) Patent Application Publication
(10) Pub. No.: US 2005/0259100 A1
(43) Pub. Date: Nov. 24, 2005

(54) Graphic processing apparatus, graphic processing system, graphic processing method and graphic processing program

(75) Inventor: Tatsuo Teruyama, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 10/952,827

(22) Filed: Sep. 30, 2004

(30) Foreign Application Priority Data
Apr. 15, 2004 (JP) 2004-120603

(51) Int. Cl. G06F 17/00; G06T 1/00; G06F 17/10

(52) U.S. Cl. 345/418

(57) ABSTRACT

A graphic processing apparatus, comprising: a plurality of stamp information storages provided corresponding to a plurality of line equations, respectively, capable of storing values obtained by inputting coordinates relating to a stamp including a plurality of pixels adjacent to each other to the corresponding line equation; a plurality of information selectors provided corresponding to said plurality of line equations, respectively, which select alternately one of information stored in said plurality of stamp information storages; a plurality of linear equation calculators provided corresponding to said plurality of line equations, which input coordinates relating to a current stamp to the corresponding linear equation based on information selected by said information selectors in order to calculate a value of the corresponding linear equation, and store the calculation results in the corresponding stamp information storage; inside/outside determination unit configured to determine whether or not a subsequent stamp adjacent to a current stamp is located inside of an area enclosed by said plurality of linear equations, based on the calculation results of said linear equation calculators corresponding to said plurality of linear equations; and a coordinate calculation unit configured to calculate a coordinate of a representative pixel in the current stamp.

### CROSS REFERENCE TO RELATED APPLICATIONS

This application claims benefit of priority under 35USC§119 to Japanese Patent Application No. 2004-120603, filed on Apr. 15, 2004, the entire contents of which are incorporated by reference herein.

### BACKGROUND OF THE INVENTION

1. Field of the Invention

The present invention relates to a graphic processing unit by which it is determined whether a stamp including a plurality of pixels exists inside or outside of linear equations.

2. Related Art

In a graphic processor, rasterizing processing to convert vertex data to pixel data is performed. In conventional rasterizing processing, inside/outside determination of a polygon is performed, or parameters are generated while conducting linear interpolation using a technique called “Digital Differential Analyzer (DDA)” (see U.S. Pat. No. 6,504,542, “Incremental and Hierarchical Hilbert Order Edge Equation Polygon Rasterization” (Michael D. McCool, Chris Wales, Kevin Moule/SIGGRAPH/EUROGRAPHICS workshop on Graphics hardware 2001 Proceedings) and “Tiled polygon traversal using half-plane edge functions” (Joel McCormack and Robert McNamara/SIGGRAPH/EUROGRAPHICS workshop on Graphics hardware 2000 Proceedings). With the DDA processing, a moving direction of a stamp is decided, using sign determination of addition results while serially adding values of edge equations. The above series of processing has to be performed in one cycle in order to achieve a throughput rate. Accordingly, high clock operation is obstructed.

Here, rasterizing means an operation which generates coordinates and parameters at each pixel in the inside of a polygon while scanning inside of the polygon, based on vertex coordinates of the polygon given by a main processor.

In the above-described DDA, the inside/outside determination of a stamp is separately performed in three stages A, B, and C. The stage A stores values of linear equations at a current stamp position and those of linear equations for a subsequent line (located at a position moved in the Y direction from the stamp by one stamp height). The stage B calculates values of the linear equations for a subsequent stamp by adding inclinations to the current values. The stage C determines whether the stamp is inside or outside the polygon, based on the signs of the linear equations.

Operations from the stage A to the stage C have to be performed in one cycle in order to move the stamp by one stamp every one cycle. That is, in DDA, it is determined whether the subsequent moving direction is X direction or Y direction based on the results by the inside/outside determination, and then the MUX at the A stage is driven. Accordingly, the above configuration becomes a critical path in LSI design to cause a bottleneck for high frequency operation.

On the other hand, when pipelining is applied in order to realize high frequency operation so that each processing at the stage A, B, or C is processed in one cycle (three cycles in total for the three stages), a stamp cannot be moved for each cycle, and only one stamp can be processed in two cycles because it is required to process operations at the stage A for a subsequent stamp after operations at the stage C. Because of this, the throughput rate of DDA is reduced from 1 to 0.5, and the arithmetic processing performance is degraded.

Or, there is considered another method by which a stamp is moved before edge determination in order to secure a throughput rate. In this case, because the stamp is moved based on prediction by the results of the edge determination to be movement in X direction, useless processing by two stamps or so is caused when the stamp comes outside the polygon in the X direction. If the polygon is comparatively large, desired performance is obtained, but lots of useless processing are caused in the movement of the stamp in the X direction, thereby degrading the performance when the polygon is so small that the number of times to turn back in the Y direction increases.

### SUMMARY OF THE INVENTION

The object of the present invention is to provide a graphic processing unit, a graphic processing system, graphic processing method and a graphic processing program by which inside/outside determination of a stamp can be made at high speed.

According to one embodiment of the present invention, graphic processing apparatus, comprising:
a plurality of stamp information storages provided corresponding to a plurality of line equations, respectively, capable of storing values obtained by inputting coordinates relating to a stamp including a plurality of pixels adjacent to each other to the corresponding line equation;
a plurality of information selectors provided corresponding to said plurality of line equations, respectively, which select alternately one of information stored in said plurality of stamp information storages;
a plurality of linear equation calculators provided corresponding to said plurality of line equations, which input coordinates relating to a current stamp to the corresponding linear equation based on information selected by said information selectors in order to calculate a value of the corresponding linear equation, and store the calculation results in the corresponding stamp information storage;
inside/outside determination unit configured to determine whether or not a subsequent stamp adjacent to a current stamp is located inside of an area enclosed by said plurality of linear equations, based on the calculation results of said linear equation calculators corresponding to said plurality of linear equations; and
a coordinate calculation unit configured to calculate a coordinate of a representative pixel in the current stamp.

### BRIEF DESCRIPTION OF THE DRAWINGS

FIG. 1 is a diagram explaining a polygon.

FIG. 2 is a diagram explaining a stamp.

FIG. 3 is a block diagram showing schematic configuration of a graphic processing apparatus according to a first embodiment of the present invention.

FIG. 4 is a block diagram showing one example of schematic configuration of a graphic processing system having a graphic processor embedding a graphic processing apparatus of FIG. 3.

FIG. 5 is a block diagram showing one example of internal configuration of a context unit and DDA control unit.

FIG. 6 is a block diagram showing one example of internal configuration of a XY context unit.

FIG. 7 is a diagram explaining procedures of a rasterizing processing of a polygon.

FIG. 8 is a diagram showing a timing in the case of rasterizing the polygon in FIG. 7.

FIG. 9 is a flowchart showing schematic processing procedure according to a first embodiment.

FIG. 10 is a diagram showing one example of a processing timing of a second embodiment.

FIG. 11 is a diagram showing sequence that threads th1 to th3 rasterize three polygons.

FIG. 12 is a flowchart showing one example of processing procedure according to a second embodiment.

FIG. 13 is a diagram explaining processing procedure according to a third embodiment.

### DETAILED DESCRIPTION OF THE INVENTION

Hereafter, a receiver and a receiving method according to the present invention will be described more specifically with reference to the drawings. In this embodiment, raster scanning of a given polygon is performed in units of stamps comprising 2×2 adjacent pixels, and a coordinate and parameters of each pixel are generated. Here, the parameters are the gradation values for red, green, and blue, a transmittance, a depth, a texture coordinate, and, a normal vector with regard to each pixel. Hereinafter, such processing is called as rasterizing.

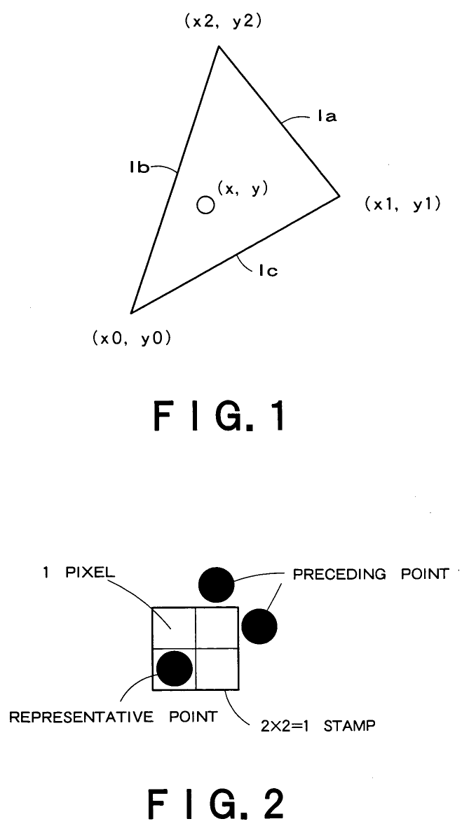

Hereinafter, it is assumed that the polygon is a triangle for simplicity. At this time, each polygon is expressed by three linear equations, Ia, Ib, and Ic, as shown in FIG. 1 Each linear equation is expressed by the following formulas (1) through (3).
Ia:a0*x+b0*y+c0 (1)
Ib:a1*x+b1*y+c1 (2)
Ic:a2*x+b2*y+c2 (3)

A current position of the stamp is indicated by coordinates of a lower-left pixel (representative point) in the stamp, as shown in FIG. 2. In the rasterizing processing, a stamp is moved one by one, and it is determined whether each stamp exists in the interior of the polygon or not. Specifically, as shown in FIG. 2, it is determined with values obtained by giving coordinates of preceding points located at the side of the current stamp to the linear equations of the formulas (1) through (3) whether the current stamp exists inside the polygon or not. Such inside/outside determination processing is performed while moving a stamp one by one in a vertical and horizontal directions. If the linear equations are calculated every time when the stamp is moved, a heavy load is necessary for calculation of the linear equations.

Then, the values of the linear equations for the current stamp are memorized in this embodiment, and the values of the linear equations for the subsequent adjacent stamp are calculated by adding inclinations of linear equations (a0, a1, a2), (b0, b1, b2) to the values.

Hereinafter, embodiments according to the present invention will be explained more specifically.

### First Embodiment

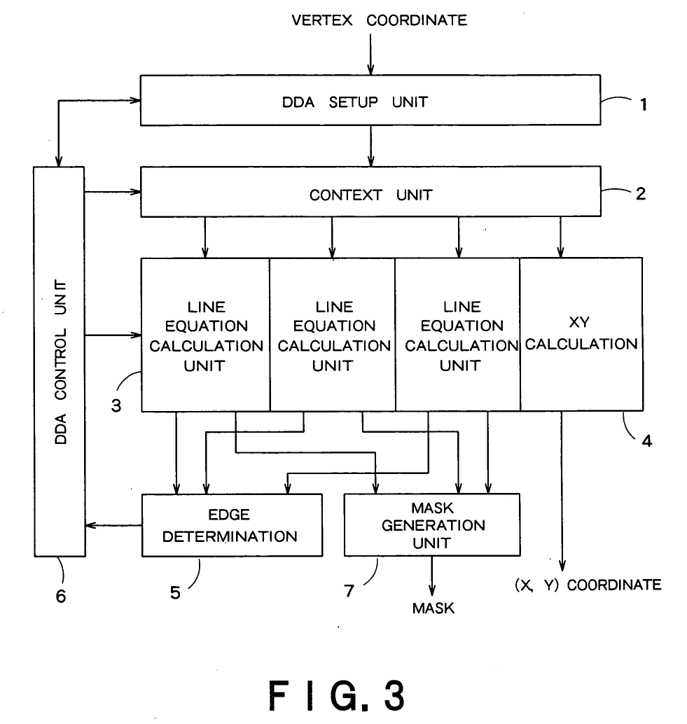

FIG. 3 is a block diagram showing a schematic configuration of a graphic processing unit according to a first embodiment of the present invention. This graphic processing unit performs rasterizing processing in which vertex data is converted into pixel data.

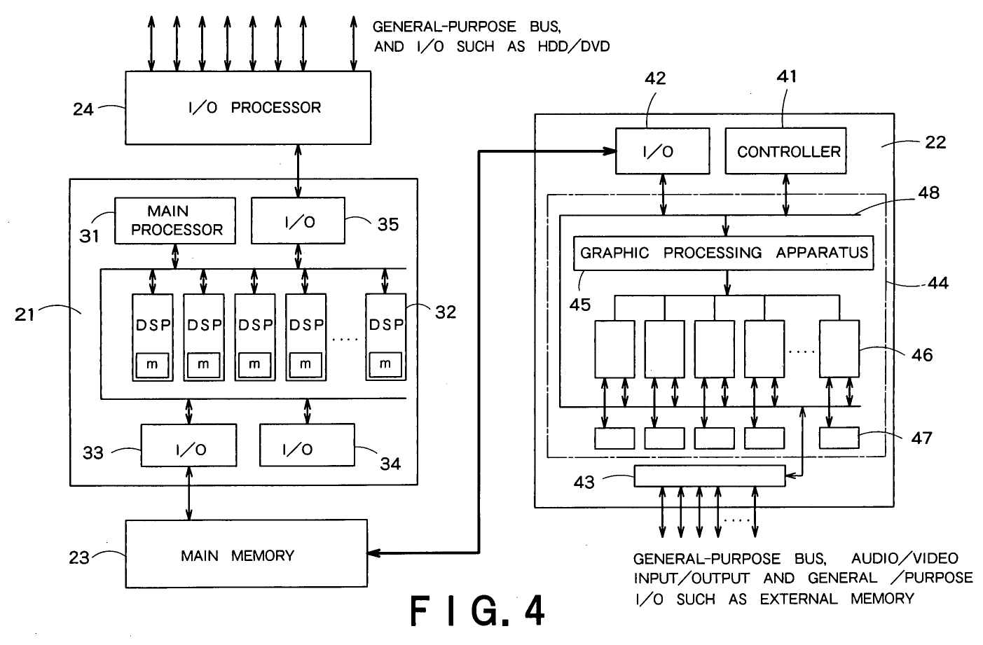

FIG. 4 is a block diagram showing one example of a schematic configuration of a graphic processing system having a graphic processor embedding the graphic processing unit shown in FIG. 3. The graphic processing system of FIG. 4 has a host processor 21, a graphic processor 22, a main memory 23 and an I/O processor 24.

The host processor 21 includes a main processor 31, a plurality of digital signal processors (DSPs) 32, and I/O sections 33, 34 and 35 which control input/output from/to the outside. The I/O unit 33, the I/O unit 34 and the I/O unit 35 control input/output from/to the main memory 23, input/output from/to the graphic processor 22 and input/output from/to the I/O processor 24, respectively.

The graphic processor 22 has a controller 41, an I/O unit 42 which exchanges data with the host processor 21, various kinds of general-purpose buss such as PCI, an I/O unit 43 which controls audio and video input/output, and a graphic processing unit 44 shown in FIG. 4.

The I/O processor 24 controls connection with a general-purpose bus, peripherals such as HDD and DVD drives, a network, and the like.

Since graphic processing in the graphic processing unit 44 is performed in parallel with that of the host processor 21, it is unnecessary for the host processor 21 to execute the three-dimensional graphic processing, thereby reducing processing load in the host processor 21, and, at the same time, executing the three-dimensional graphic processing at high speed.

The graphic processing unit 44 has a graphic processing unit 45, a plurality of arithmetic units 46, and a memory 47, as shown in FIG. 3. The graphic processing unit 45, the arithmetic units 46 and the memory 47 are connected to a local network 48.

In the graphic processing unit 45, the coordinate and the parameters of each pixel in a stamp are calculated for each stamp having 2×2 adjacent pixels, and the calculation results are supplied to the corresponding arithmetic unit 46. The plurality of arithmetic units 46 can execute processings in parallel with one another. That is, each arithmetic unit 46 executes processing for the stamp different from one another. The operation results in the arithmetic units 46 are stored in the memory 47.

Since the plurality of arithmetic units 46 shown in FIG. 4 can perform graphic processing in parallel with one another, graphic processing can be executed at high speed.

Returning to FIG. 3, the graphic processing unit 45 includes a DDA setup unit 1, a context unit 2, a linear-equation calculation unit 3, an XY calculation unit 4, an edge determination unit 5, a DDA control unit 6 and a mask generation unit 7. The DDA control unit 6 calculates (X, Y) coordinates of a starting point for rasterizing, values of linear equations (initial values Ia, Ib, and Ic), and inclinations of the linear equations (dIa/dx, dIa/dy, dIb/dx, dIb/dy, dIc/dx, dIc/dy) at the coordinates. The initial values are stored in an ACC register and a Save register of the context unit 2. The inclinations of the linear equations are stored in a dIdx register and a dIdy register of the context unit 2.

The context unit 2, the linear-equation calculation unit 3 and the DDA control unit 6 are provided corresponding to each of the three linear equations forming a polygon.

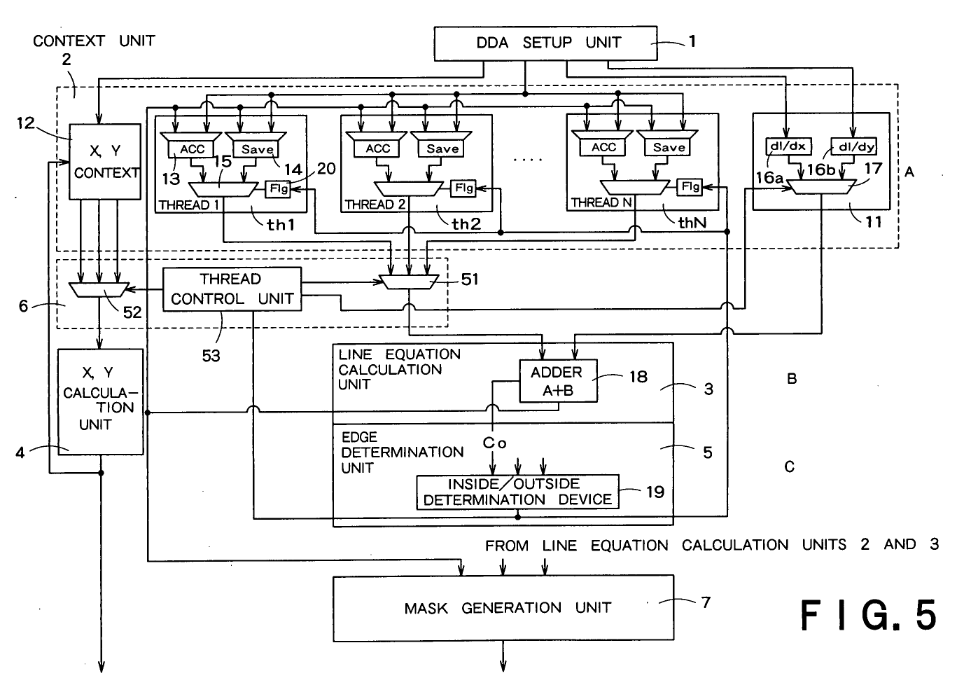

FIG. 5 is a block diagram showing internal configurations of the context unit 2 and the DDA control unit 6 as one example. As shown in the drawing, each context unit 2 comprises a plurality of threads the through thN which can reserve calculation results of linear equations, a inclination context unit 11 reserving inclinations of the linear equations, and an XY context unit 12 which reserves (x, y) coordinates of a representative point in the stamp.

Each of the plurality of threads has a multiplexer and an ACC register 13, which stores values of linear equations for preceding points of the current stamp, a multiplexer and an Save register 14, which store values of linear equations for preceding points of the stamp moved by one stamp in the Y direction, and a multiplexer 15 which selects a value stored in the ACC register 13 or the Save register 14.

The inclination context unit 11 includes a dIdx register 16a which stores inclinations dI/dx for the linear equations in the X direction, a dIdy register 16b which stores inclinations dI/dy for the linear equations in the Y direction, and a multiplexer 17 which selects values of the dIdx register 16a of the dI/dy register 16b.

An adder 18 in the linear-equation calculation unit 3 calculates values of linear equations for preceding points in the subsequent stamp by adding values outputted from any one of the threads in the corresponding context unit 2, and values outputted from the inclination context unit 11.

When all of the values calculated in the three linear-equation calculation sections 3 indicate existing in the inside of the polygon, an inside/outside determination device 19 of the edge determination unit 5 determines that a stamp exists inside a polygon. When any one of the values calculated in the three linear-equation calculation sections 3 indicates existing outside the polygon, it is determined that a stamp exists outside a polygon.

The DDA control unit 6 includes a multiplexer 51 which selects any one of outputs of the threads the through thN, a multiplexer 52 which selects the corresponding coordinates (x, y) from outputs of the XY context unit 12 and a thread control unit 53 which controls selection in the above multiplexers.

The mask generation unit 7 calculates coordinates (x, y) of each pixel in the current stamp, based on the values calculated in the three linear-equation calculation unit 3.

The XY context unit 12 stores coordinates (x, y) of a representative point in a stamp for the starting point in the first place, and then, coordinates (x, y) of a representative point in the current stamp are stored therein. Specifically, coordinates (x, y) of representative points are stored for each of the threads the through thN.

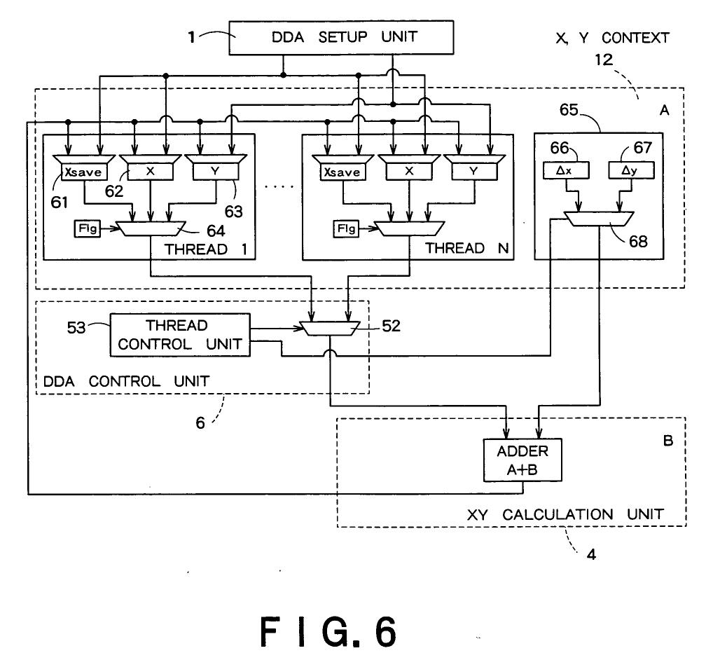

FIG. 6 is a block diagram showing an internal configuration of the XY context unit 12 as one example. As shown in the drawing, the XY context unit 12 includes a multiplexer and an Xsave register 61, a multiplexer and an X register 62, a multiplexer and a Y register 63, and a multiplexer 64 for selecting any one of outputs from the above registers 61 through 63, which are provided for each thread. These registers store coordinates (x, y) of the representative point in the current stamp. The XY context unit 12 includes a coordinate increment storing unit 65 by which coordinates of a stamp are moved by one stamp. The coordinate increment storing unit 65 comprises a Δx register 66 which stores a distance Δx in the X-coordinate direction for one stamp, a Δy register 67 which stores a distance Δy in the Y-coordinate direction for one stamp, and a multiplexer 68 which selects one of the above registers 66 and 67.

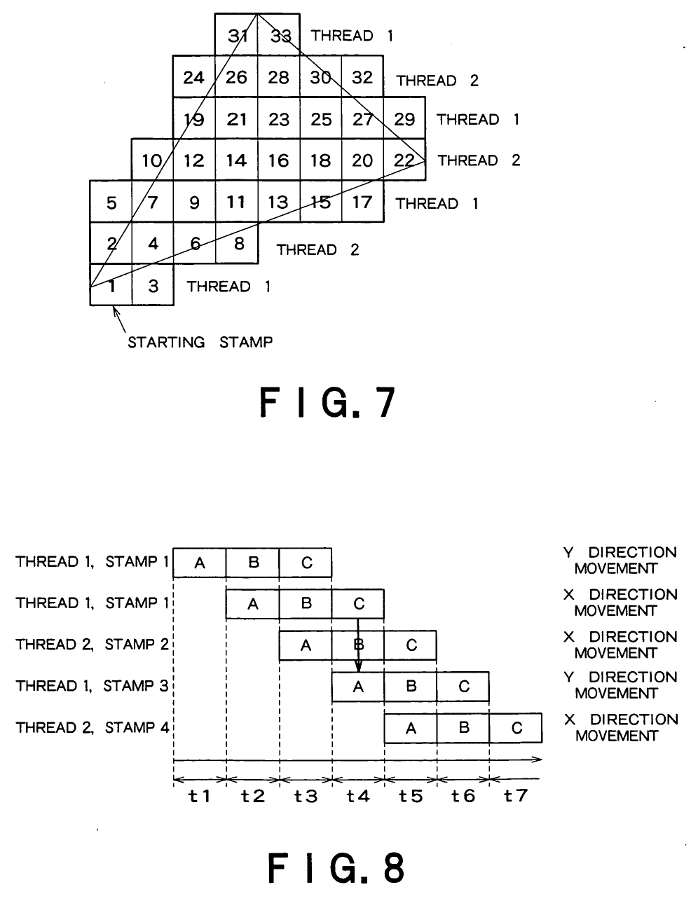

FIG. 7 is a view explaining rasterizing procedures of the polygon. In the example of FIG. 7, stamps which are adjacent to each other in the X direction are processed with a same thread, stamps adjacent to each other in the Y direction are processed with the thread different from each other.

Specifically, rasterizing is performed by using the two threads the and th2. First of all, a stamp 1 is set as a starting point, and a stamp 2 adjacent in the Y direction is processed in the thread th2. Inside/outside determination, coordinate detection of each pixel forming the stamp 2, and parameter calculation for each pixel are processed for the stamp 2. Subsequently, a stamp 3 adjacent to the right of the stamp 1 is processed in the thread the, and, thereafter, a stamp 4 adjacent to the right of the stamp 2 is processed in the thread th2. As described above, processing is performed in the threads the and th2 alternately.

Processing in the threads the and th2 is executed in three stages A, B, and C, respectively. Processing at the stage A is performed in the context unit 2 shown in FIG. 3. Processing at the stage B is performed in the linear-equation calculation unit 3. Processing at the stage C is performed in the edge determination unit 5.

FIG. 8 is a view showing timing in the case of rasterizing the polygon in FIG. 7. As shown in the drawing, processing is continuously performed two times in the thread the as a first step, and, thereafter, processing is executed in the threads th2 and the, alternately. Processing is performed in the threads the and th2, staggering the starting time by one cycle, and processing in each thread is completed in three cycles.

As seen from FIG. 8, movement in the Y direction is started, in the thread the (cycle t1) by setting the stamp 1 as the starting point. At a next cycle t2, movement in the X direction is started from the stamp 1 in the thread the (cycle t1). At a subsequent cycle t3, movement in the X direction is started from the stamp 2 in the thread th2. At a next cycle t4, movement in the Y direction is started from the stamp 3 in the thread th1. At a subsequent cycle t5, movement in the X direction is started from the stamp 4 in the thread th2.

For example, when attention is paid to the cycle t4, processing at the stage A for the stamp 3 is performed in the thread th2, while processing at the stage C for the stamp 1 is performed in the thread th1. In this way, processings in the threads the and th2 are simultaneously performed.

At the cycle t4, the edge determination unit 5 recognizes that the preceding point (of the stamp 3) goes out of the polygon when the stamp 1 is moved in the X direction. Because of this, a flag 20 is set. The flag 20 is sent to the thread the during the same cycle. At this time, since processing in the cycle A for the stamp 3 is performed in the thread the, the edge determination unit 5 recognizes that no stamp to be processed is found at the right side of the stamp 3, and movement in the Y direction is processed.

As described above, the present embodiment is characterized in that a moving direction of a stamp is decided in the same cycle, based on determination results of whether the preceding points of a stamp are located in the inside of a polygon or not. Accordingly, useless stamp processing does not need to be performed, different from the conventional technique, thereby improving the efficiency of processing.

Hereinafter, operations of the graphic processing unit 45 according to a first embodiment will be explained, referring to one example in which the polygon in FIG. 7 is rasterized. First of all, it is assumed that processing is started from the stamp 1 in FIG. 7, using the thread the as a starting point.

(1-1) Thread the, Stamp 1, Movement in the Y direction, and Stage A (Cycle t1 in FIG. 8)

The values of the linear equations for the preceding points of the stamp 1 are stored in the ACC register 13 and the Save register 14 of the thread the, the coordinates (X, Y) of the representative point of the stamp 1 are stored in X and Y registers of the XY context unit 12, and the X coordinate of the representative point is stored in the XSave register 61.

Since movement in the Y direction is firstly started, the output of the Y register 63 of the X and Y registers 62 and 63, is selected and supplied to the XY calculation unit 4 by the multiplexer 52 in the DDA control unit 6. Moreover, an increment value Δy in the Y direction is selected, and supplied to the XY calculation unit 4 by the multiplexer 68 in the XY context unit 12.

On the other hand, the multiplexers 15 in the threads th1 through thN select values of the Save register 14. The multiplexer in the DDA control unit 6 selects the output of the thread the, and supplies it to the linear-equation calculation unit 3. Moreover, the multiplexer in the inclination context unit 11 selects the dIa/dy, and supplies it to the linear-equation calculation unit 3. The above-described processing is performed for the three linear-equation calculation sections 3, respectively.

(1-2) Thread the, Stamp 1, Movement in the Y direction, and Stage B (Cycle t2 in FIG. 8)

Y+Δy is calculated in the XY calculation unit 4. Moreover, the three linear-equation calculation sections 3 perform addition of Ia+dIady, respectively, and output the calculation results.

(1-3) Thread the, Stamp 1, Movement in the Y direction, and Stage C (Cycle t3 in FIG. 8)

The edge determination unit 5 checks signs of output values. If all the signs are positive, the edge determination unit 5 determines that the preceding point exists inside the polygon. If at least one of the signs is negative, the edge determination unit 5 determines that the preceding point exists outside the polygon. Since the calculated values of the linear equations are the values for the preceding points of the stamp 2, all the signs are positive, and the polygon is determined to exist inside the polygon in the case of the polygon shown in FIG. 7. Next, it is determined to move the stamp until the position of the stamp 5 in the X direction.

The calculated values of the linear equations are stored in the ACC register 13 and the Save register 14 of the thread th2. Moreover, the Y coordinate values are stored in the Y register 63 of the XY context unit 12, and the values of the XSave register 61 are stored in the X register 62. Moreover, the X coordinate is stored in the XSave register 61, because the stamp is a first stamp in the polygon after the movement in the Y direction.

(2) Movement from Stamp 1 to Stamp 3

(2-1) Thread th1, Stamp 1, Movement in the X direction, and Stage A (Cycle t2 in FIG. 8)

The values of the linear equations for the preceding points of the stamp 1 are stored in the ACC register 13 and the Save register 14 of the thread th1, and the X and Y registers 62 and 63 of the representative point are stored in the X and Y registers 62 and 63 of the XY context unit 12. Moreover, the X coordinate of the representative point for the stamp 1 is stored in the XSave register 61. For movement in the X direction, the value of the X register 62, the values of the Δx and the ACC register 13 are outputted. The output of the thread the is selected by the DDA control unit 6.

(2-2) Thread th1, Stamp 1, Movement in the X direction, and Stage B (Cycle t3 in FIG. 8)

X+Δx is calculated in the XY calculation unit 4. Moreover, Ia+dIa/dx is calculated in the three linear-equation calculation sections 3, respectively, and the calculation results are output.

(2-3) Thread the, Stamp 1, Movement in the X direction, and Stage C (Cycle t4 in FIG. 8)

The edge determination unit 5 checks signs of output values. In this case, the values of the linear equations at the preceding point for the stamp 3 after the movement are checked. Based on the check results, it is determined that the preceding points exist outside the polygon, and a flag to the effect is set.

(3) Movement from Stamp 2 to Stamp 4

In this case, the thread th2 is operated in a similar manner to that of (2), because of the movement in the X direction. Since the preceding points for the stamp 4 after the movement are located inside the polygon, processing at the stage C is different from that of (2-3).

(3-3) Thread th2, Stamp 2, Movement in the X direction, and Stage C (Cycle t5 in FIG. 8)

In this case, all the outputs of the three linear-equation calculation unit 3 are positive. Therefore, the values of the linear equations are stored in the ACC register 13, and the X coordinate of the stamp 4 is stored in the X register 62.

(4) Movement from Stamp 3 to Stamp 5

Since the flag indicative of the preceding point for the stamp 3 exists outside the polygon is set in the above-described (2-3), movement in the Y direction is performed in the thread th1.

(4-1) Thread th1, Stamp 3, Movement in the Y direction, and Stage A (Cycle t4 in FIG. 8)

Since the flag indicative of movement in the Y direction is set, the thread the outputs the value of the linear-equation (value of the preceding point for the stamp 1) stored in the Save register 14. Moreover, the XY context unit 12 outputs the values of the Y register 63 and Δy. Moreover, the inclination context unit 11 outputs dIady.

(4-2) Thread th1, Stamp 3, Movement in the Y direction, and Stage B (Cycle t5 in FIG. 8)

The XY calculation unit 4 calculates Y+Δy. Ia+dIa/dy is calculated in the three linear-equation calculation sections 3, respectively, and the calculation results are output.

(4-3) Thread th1, Stamp 3, Movement in the Y direction, and Stage C (Cycle t6 in FIG. 8)

The edge determination unit 5 determines that the preceding points after the movement exists inside the triangle, and the values of the linear equations are stored in the ACC register 13 and the Save register 14 of the thread the. The reason for storing them in the Save register 14 is that it has been determined to exist inside the polygon. Then, the added Y coordinate value is stored in the Y register 63 of thread the. Moreover, the values of the XSave register 61, and those of the X register 62 are stored in the X register 62 and in the XSave register 61, respectively.

The above-described processings are performed one by one for each stamp, and, when processing for the last stamp in the polygon is completed, the processings for the polygon are completed.

In the above embodiment, one example in which two threads are alternately switched and processed has been described. More than two threads may be alternately switched and processed. When three or more threads are used, it is possible to obtain more sufficient time from delivery of flags to switching between X and Y coordinates.

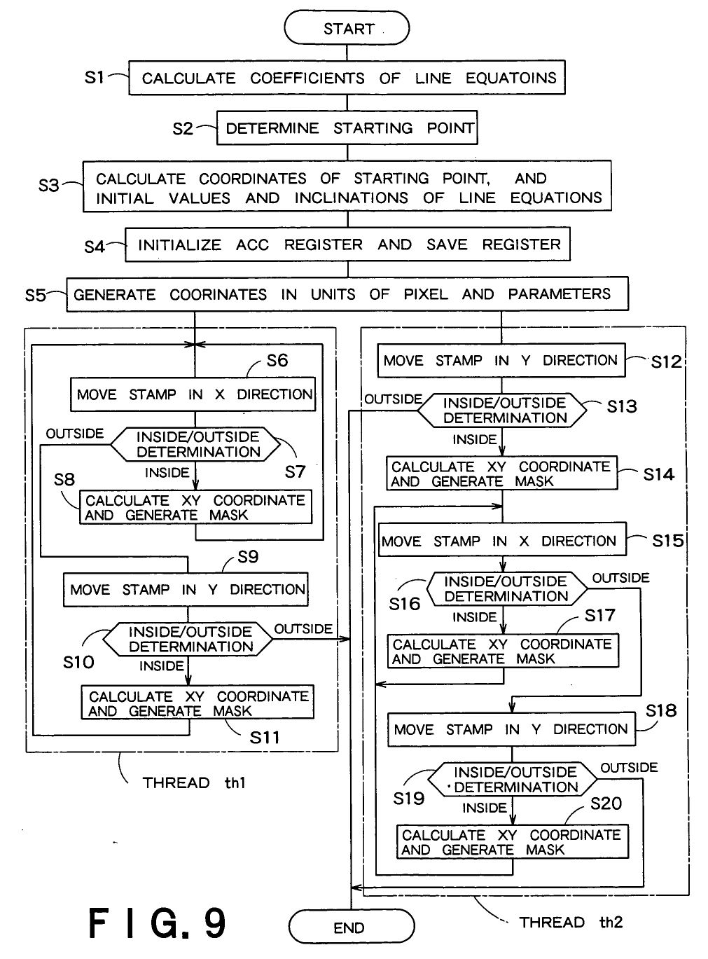

FIG. 9 is a flowchart showing a schematic processing procedure according to the first embodiment. First of all, the DDA setup unit 1 calculates the coefficients of the linear equations (STEP S1), and decides the starting point (STEP S2). Subsequently, the DDA setup unit 1 calculates the coordinates of the starting point, and the initial values and the inclinations of the linear equations (STEP S3). Next, the context unit 2 initializes the ACC register 13 and the Save register 14 (STEP S4). Subsequently, the mask generation unit 7 generates coordinates and parameters of each pixel (STEP S5).

Thereafter, processing is alternately performed in the threads the and th2. First of all, processing in the thread the will be explained. The thread the moves the stamp in the thread the in the X direction by one stamp (STEP S6), and, with regard to the preceding point of the stamp after the movement, executes the inside/outside determination (STEP S7). When it is determined that the points exist inside the polygon, the mask generation unit 7 calculates the XY coordinates of each pixel in the stamp after the movement, and, at the same time, generates parameters of the pixels (STEP S8). Next, the processing returns to STEP S6.

On the other hand, when it is determined at STEP S7 that the stamp exists outside the polygon, the stamp is moved in the Y direction by one stamp (STEP S9). Subsequently, it is determined (STEP S10) whether the stamp after the movement is located inside the polygon, and, when it is decided that the stamp is located inside, the processing returns to STEP S6 after calculating the XY coordinates and the parameters for each pixel in the stamp after the movement. On the other hand, when it is determined at STEP S10 that the stamp exists outside the polygon, the processing is completed.

Next, processing in the thread th2 will be explained. In thread th2, a stamp is moved in the Y direction (STEP S1), and the inside/outside determination is performed (STEP S12). When it is determined that the stamp after the movement is located inside the polygon, the XY coordinates and the parameters of each pixel in the stamp are calculated (STEP S13).

Subsequently, the stamp is moved in the X direction by one stamp (STEP S14), and the inside/outside determination is performed (STEP S15). When it is determined that the stamp after the movement is located inside the polygon, the XY coordinates and the parameters of each pixel in the stamp are calculated (STEP S16), and the processing returns to STEP S14.

On the other hand, when it is determined at STEP S15 that the stamp exists outside the polygon, the stamp is moved in the Y direction by one stamp (STEP S17). Subsequently, the inside/outside determination is made for the stamp after the movement (STEP S18). When it is determined that the stamp after the movement is located inside the polygon, the XY coordinates and the parameters of each pixel in the stamp are calculated (STEP S19), and the processing returns to STEP S14.

On the other hand, when it is determined at STEP S12 or STEP S18 that the stamp exists outside the polygon, the processing is completed.

Since the first embodiment has the above-described configuration in which a stamp is processed while a plurality of threads are alternately switched, and, when it is determined that the stamp exists outside a polygon, the stamp has been instantaneously switched to be processed as a subsequent step. Therefore, there is no possibility that stamps outside the polygon are uselessly processed, thereby performing effective rasterizing processing. Moreover, since a plurality of threads are alternately switched and processed, it is possible to share the linear-equation calculation unit 3 and the edge determination unit 5 with a plurality of threads, thereby simplifying the entire configurations.

### Second Embodiment

In a second embodiment, each stamp is processed by allocating different threads for respective adjacent polygons.

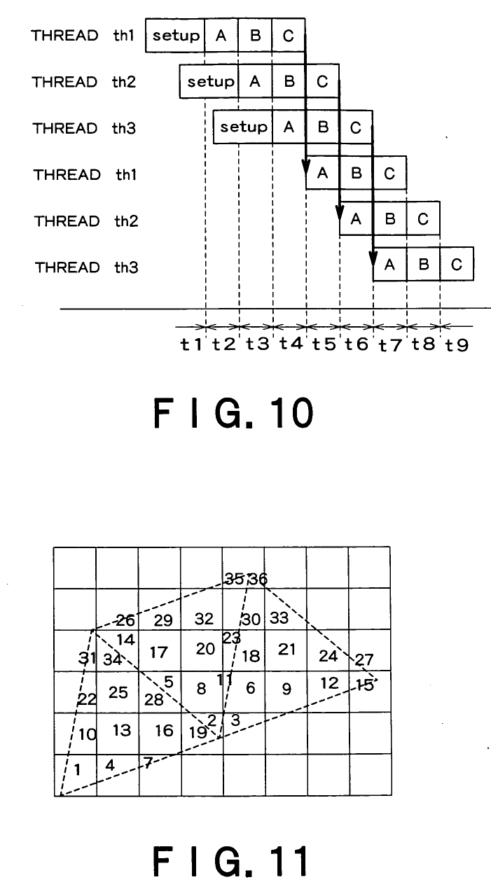

FIG. 10 is a view showing one example for processing timing in the second embodiment. The drawing shows one example in which processing is executed, using three threads the through th3.

First of all, a thread the performs initial setting at cycle t1 in order to process a stamp in a polygon 1. Thereafter, with respect to the stamp of the starting point, the thread the performs the processing at stage A at cycle t2, the processing at stage B at cycle t3, and the processing at stage C at cycle t4.

On the other hand, a thread th2 performs initial setting for a polygon 2 at cycle t2. Thereafter, with respect to the stamp of the starting point, the thread th2 performs the processing at stage A at cycle t3, the processing at stage B at cycle t4 and the processing at stage C at cycle t5.

Furthermore, a thread th3 performs initial setting for a polygon 3 at cycle t3. Thereafter, with respect to the stamp of the starting point, the thread th3 performs the processing at stage A at cycle t4, the processing at stage B at cycle t5 and the processing at stage C at cycle t6.

Hereafter, stamps in corresponding polygons are sequentially processed in the threads the through th3. When processing of the last stamp in a polygon is completed, similar processing is performed for a next polygon. When a certain thread finishes processing for one polygon, the thread performs initial setting for a subsequent polygon, and then performs the stamp in the same procedure.

FIG. 11 is a view showing processing orders in which the threads th1-th3 rasterize three polygons. As shown in the drawing, the threads th1-th3 rasterize the polygon p1-p3, respectively.

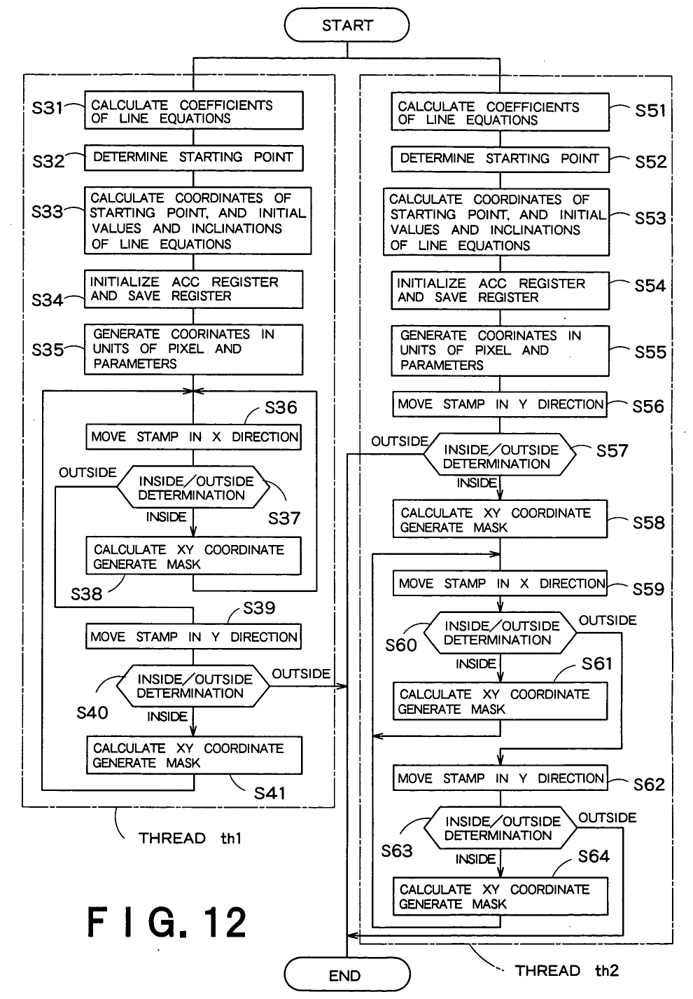

FIG. 12 is a flowchart showing one example of a processing procedure according to the second embodiment. This flowchart shows an example in which polygons different from one another are processed in two threads, respectively. The difference between FIG. 12 and FIG. 9 is that initial setting is made in each thread (STEP S31 through STEP S35, and STEP S51 through STEP S55). Processing other than the above point is similar to that of FIG. 9.

As described above, according to the second embodiment, one polygon is processed in one thread, and a plurality of threads alternately perform rasterizing. Because of this, when size of the polygon is small, it is possible to perform processing more effectively than that of the first embodiment.

### Third Embodiment

In a third embodiment, processing is executed for each stamp along two linear equations among three ones forming a polygon (hereafter, called a starting side and a end side).

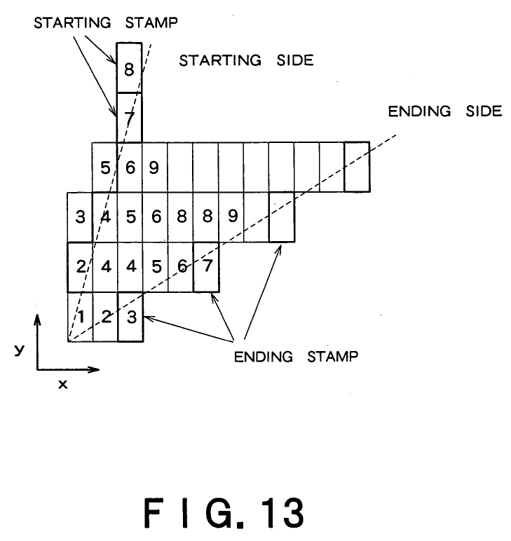

FIG. 13 is a view explaining a processing procedure according to the third embodiment. Processing is performed by one stamp along the starting and the end sides, alternately. At this time, a stamp is moved to the inside by one stamp when the stamp goes out of each side. For example, in the case of the starting side, processing is performed in the order of stamps 1, 2, 3, 4, 5, 6, 7, and 8 in FIG. 13. Moreover, in the case of the end side, processing is performed in the order of stamps 1, 2, 3, 4, 5, 6, 7, 8, and 9.

Then, a distance from a stamp along the starting side to a stamp along the end side is memorized for each line parallel to the X direction.

Subsequently, with regard to a stamp located between the starting side and the end one, edge determination is made according not to a sign of a linear equation, but to the above-described distance. Therefore, it is possible easily to determine whether the stamp is located between the starting side and the end side or not.

In the case of the third embodiment, three kinds of scanning, i.e. scanning along the starting side, scanning along the end side, and intermediate scanning between the starting and end sides, are required in total, but only two kinds of scanning are actually necessary because the scanning along the starting side and the intermediate scanning can be performed in an integrated manner.

As described above, according to the third embodiment, the processing of the stamp is performed along the starting side and the end side of the polygon, it is unnecessary to perform inside/outside determination using three line equations similar to the first and second embodiments.

There are no special limitations on specific contents of graphic processing by the above-described graphic processing unit. Three-dimensional or two-dimensional graphic processing may be applied to the present invention. Moreover, the graphic processing unit shown in FIG. 3 does not necessarily require connection to the host processor 21 in FIG. 4. Furthermore, a chip may comprise only the graphic processing unit, and a graphic processor 22 in FIG. 4 may be formed as one chip, or the host processor 21 and the graphic processor 22 in FIG. 4 may be formed as one chip.

Moreover, although cases in which a 2×2 stamp is used have been explained in the above-described embodiments, there are no special limitations on the number of pixels forming a stamp. Furthermore, the shape of a polygon is not limited to a triangle, therefore, a polygon with four sides or more may be applied to the present invention.

The graphic processing unit and the graphic processing system described in the above embodiment may be constituted as hardware or software. When the graphic processing unit and the graphic processing system are constituted as software, a program which realizes at least some functions of the graphic processing unit and the graphic processing system may be stored in a recording medium such as a floppy disk or a CD-ROM or the like, loaded on a computer, and then executed by the computer. The recording medium is not limited to a portable recording medium such as a magnetic disk or an optical disk. A fixed recording medium such as a hard disk drive or a memory may be used.

A program which realizes at least some functions of the graphic processing unit and the graphic processing system may be distributed through a communication network (including wireless communication) such as the Internet or the like. In addition, the program may be coded, modulated, or compressed and then distributed through a cable network or a wireless network such as the Internet. Alternatively, the program may be distributed being stored in a recording medium.

1. A graphic processing apparatus, comprising:
a plurality of stamp information storages provided corresponding to a plurality of line equations, respectively, capable of storing values obtained by inputting coordinates relating to a stamp including a plurality of pixels adjacent to each other to the corresponding line equation;
a plurality of information selectors provided corresponding to said plurality of line equations, respectively, which select alternately one of information stored in said plurality of stamp information storages;
a plurality of linear equation calculators provided corresponding to said plurality of line equations, which input coordinates relating to a current stamp to the corresponding linear equation based on information selected by said information selectors in order to calculate a value of the corresponding linear equation, and store the calculation results in the corresponding stamp information storage;
inside/outside determination unit configured to determine whether or not a subsequent stamp adjacent to a current stamp is located inside of an area enclosed by said plurality of linear equations, based on the calculation results of said linear equation calculators corresponding to said plurality of linear equations; and
a coordinate calculation unit configured to calculate a coordinate of a representative pixel in the current stamp.

2. The graphic processing apparatus according to claim 1,
wherein said stamp information storages includes:
a first value storage which stores values of the linear equations in the case of moving the current stamp for one stamp in a first direction;
a second value storage which stores values of the linear equations in the case of moving the current stamp for one stamp in a second direction; and
a value selector which selects and outputs the values stored in either of said first or second value storage.

3. The graphic processing apparatus according to claim 1, wherein the storing processings by said stamp information storages, the calculation processings by said linear equation calculators and the determination processing by said inside/outside determination unit are performed in parallel.

4. The graphic processing apparatus according to claim 1, further comprising an inclination storage which stores an inclination in X direction and an inclination in Y direction in said linear equations,
wherein said information selectors select the inclination in X or Y direction stored in said inclination storage based on the determination results of said inside/outside determination unit; and
said linear equation calculators add the inclinations in X or Y direction selected by said information selectors to information stored in any one of said stamp information storages selected by said information selectors, in order to calculate the linear equations relating to the current stamp.

5. The graphic processing apparatus according to claim 1, further comprising an pixel information calculator which calculates coordinates and parameters of all the pixels in the current pixel based on the calculation results of said linear equation calculators corresponding to said plurality of linear equations.

6. The graphic processing apparatus according to claim 5, wherein the parameters include gradation values of RGB, transmittance information, depth information, texture coordinates and normal vectors.

7. The graphic processing apparatus according to claim 1, wherein the value of the linear equation relating to the stamp for one line adjacent in a first direction, and the value of the linear equation relating to the stamp for one line adjacent in a second direction are stored in said stamp information storages different from each other.

8. The graphic processing apparatus according to claim 1, wherein the values of the linear equations relating to the stamps included in a plurality of polygons are stored in said stamp information storages separate from each other.

9. A graphic processing system, comprising:
a vertex data supplying apparatus which provides vertex data of polygons;
a graphic processing apparatus which generates coordinates and parameters for each pixel based on the vertex data;
a storage which stores the coordinates and the parameters, wherein said graphic processing apparatus includes:
a plurality of stamp information storages provided corresponding to a plurality of line equations, respectively, capable of storing values obtained by inputting coordinates relating to a stamp including a plurality of pixels adjacent to each other to the corresponding line equation;
a plurality of information selectors provided corresponding to said plurality of line equations, respectively, which select alternately one of information stored in said plurality of stamp information storages;
a plurality of linear equation calculators provided corresponding to said plurality of line equations, which input coordinates relating to a current stamp to the corresponding linear equation based on information selected by said information selectors in order to calculate a value of the corresponding linear equation, and store the calculation results in the corresponding stamp information storage;
inside/outside determination unit configured to determine whether or not a subsequent stamp adjacent to a current stamp is located inside of an area enclosed by said plurality of linear equations, based on the calculation results of said linear equation calculators corresponding to said plurality of linear equations; and
a coordinate calculation unit configured to calculate a coordinate of a representative pixel in the current stamp.

10. The graphic processing system according to claim 9,
wherein said stamp information storages includes:
a first value storage which stores values of the linear equations in the case of moving the current stamp for one stamp in a first direction;
a second value storage which stores values of the linear equations in the case of moving the current stamp for one stamp in a second direction; and
a value selector which selects and outputs the values stored in either of said first or second value storage.

11. The graphic processing system according to claim 9, wherein the storing processings by said stamp information storages, the calculation processings by said linear equation calculators and the determination processing by said inside/outside determination unit are performed in parallel.

12. The graphic processing system according to claim 9, further comprising an inclination storage which stores an inclination in X direction and an inclination in Y direction in said linear equations,
wherein said information selectors select the inclination in X or Y direction stored in said inclination storage based on the determination results of said inside/outside determination unit; and
said linear equation calculators add the inclinations in X or Y direction selected by said information selectors to information stored in any one of said stamp information storages selected by said information selectors, in order to calculate the linear equations relating to the current stamp.

13. The graphic processing system according to claim 9, further comprising an pixel information calculator which calculates coordinates and parameters of all the pixels in the current pixel based on the calculation results of said linear equation calculators corresponding to said plurality of linear equations.

14. The graphic processing system according to claim 13, wherein the parameters include gradation values of RGB, transmittance information, depth information, texture coordinates and normal vectors.

15. The graphic processing system according to claim 9, wherein the value of the linear equation relating to the stamp for one line adjacent in a first direction, and the value of the linear equation relating to the stamp for one line adjacent in a second direction are stored in said stamp information storages different from each other.

16. The graphic processing system according to claim 9, wherein the values of the linear equations relating to the stamps included in a plurality of polygons are stored in said stamp information storages separate from each other.

17. A graphic processing method, comprising:
storing a value obtained by inputting coordinates relating to a stamp including a plurality of pixels adjacent to each other to a corresponding line equation, into a plurality of stamp information storages provided corresponding to a plurality of line equations;
selecting alternately one of information stored in the plurality of stamp information storages by a plurality of information selectors provided corresponding to the plurality of line equations;
inputting coordinates relating to a current stamp based on information selected by said information selectors to the corresponding line equation in order to calculate a value of the linear equation by a plurality of linear equation calculators provided corresponding to the plurality of linear equations, and storing the calculation results in the corresponding stamp information storage;
determining whether or not a subsequent stamp adjacent to the current stamp is located inside of an area enclosed by a plurality of line equations, based on the calculation results of said line equation calculators corresponding to said plurality of line equations; and
calculating a coordinate of a representative pixel in the current stamp.

18. The graphic processing method according to claim 17, wherein said stamp information storages includes:
storing values of the line equations in the case of moving the current stamp for one stamp in a first direction in a first value storage;
storing values of the line equations in the case of moving the current stamp for one stamp in a first direction in a second value storage; and
selecting and outputting the values stored in either of said first or second value storage, based on the determination results of whether or not the subsequent stamp adjacent to the current stamp is located inside of the area enclosed by said linear equations.

19. A graphic processing program capable of being executed by a computer, comprising the steps of:
storing a value obtained by inputting coordinates relating to a stamp including a plurality of pixels adjacent to each other to a corresponding line equation, into a plurality of stamp information storages provided corresponding to a plurality of line equations;
selecting alternately one of information stored in the plurality of stamp information storages by a plurality of information selectors provided corresponding to the plurality of line equations;
inputting coordinates relating to a current stamp based on information selected by said information selectors to the corresponding line equation in order to calculate a value of the linear equation by a plurality of linear equation calculators provided corresponding to the plurality of linear equations, and storing the calculation results in the corresponding stamp information storage;
determining whether or not a subsequent stamp adjacent to the current stamp is located inside of an area enclosed by a plurality of line equations, based on the calculation results of said line equation calculators corresponding to said plurality of line equations; and
calculating a coordinate of a representative pixel in the current stamp.

20. The graphic processing program according to claim 19, wherein said stamp information storages includes the steps of:
storing values of the line equations in the case of moving the current stamp for one stamp in a first direction in a first value storage;
storing values of the line equations in the case of moving the current stamp for one stamp in a first direction in a second value storage; and
selecting and outputting the values stored in either of said first or second value storage, based on the determination results of whether or not the subsequent stamp adjacent to the current stamp is located inside of the area enclosed by said linear equations.
